(19) United States
(12) Patent Application Publication
(10) Pub. No.: US 2026/0172695 A1
(43) Pub. Date: Jun. 18, 2026

(54) CONTROL APPARATUS, IMAGE PICKUP APPARATUS, CONTROL METHOD, AND STORAGE MEDIUM

(71) Applicant: CANON KABUSHIKI KAISHA, Tokyo (JP)

(72) Inventor: KAIHEI KITAMURA, Kanagawa (JP)

(21) Appl. No.: 19/365,505

(22) Filed: Oct. 22, 2025

(30) Foreign Application Priority Data
Dec. 16, 2024 (JP) 2024-220204

(51) Int. Cl. H04N 23/73; H04N 23/76

(52) U.S. Cl. CPC H04N 23/73; H04N 23/76

(57) ABSTRACT

A control apparatus includes one or more memories storing instructions, and one or more processors that, upon execution of the instructions, operate to acquire information about an object included in an image generated by imaging through an optical system, and select, based on the information about the object, at least one of inserting an ND filter into an optical path in the optical system and performing combination processing by combining a plurality of images generated by the imaging to achieve a light reduction effect.

### BACKGROUND

### Field of the Technology

The disclosure relates to one or more embodiments of a control apparatus, an image pickup apparatus, a control method, and a storage medium.

### Description of the Related Art

In capturing an image, a proper exposure amount can be obtained by inserting or removing a neutral density (ND) filter into or from an optical path in an optical system according to the luminance of the object. Japanese Patent Application Laid-Open No. 2013-157688 discloses an image pickup apparatus that controls exposure in reducing the amount of light captured by an image sensor, by inserting or removing an ND filter or changing the exposure time, aperture value (F-number), ISO speed, etc., based on information such as panning and exposure time. Japanese Patent Application Laid-Open No. 2023-141237 discloses an image pickup apparatus that obtains an image with a proper exposure by combining a plurality of images obtained by capturing images multiple times without using an ND filter.

### SUMMARY

One or more embodiments of a control apparatus according to one or more aspects of the disclosure may include one or more memories storing instructions, and one or more processors that, upon execution of the instructions, operate to acquire information about an object included in an image generated by imaging through an optical system, and select, based on the information about the object, at least one of inserting an ND filter into an optical path in the optical system and performing combination processing by combining a plurality of images generated by the imaging to achieve a light reduction effect. One or more image pickup apparatuses may include one or more control apparatuses in accordance with one or more other aspects of the disclosure. One or more control methods corresponding to the above one or more control apparatuses also constitutes another aspect of the disclosure. A storage medium storing a program that causes a computer to execute the above one or more control methods also constitutes another aspect of the disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating the configuration of an image pickup apparatus according to this embodiment.

FIG. 2 illustrates the configuration of a light reduction information generator in the image pickup apparatus according to this embodiment.

FIGS. 3A, 3B, 3C, and 3D illustrate light reduction processing in the image pickup apparatus according to this embodiment.

FIG. 4 illustrates the configuration of a light reduction method determining unit in the image pickup apparatus according to this embodiment.

FIG. 5 is a flowchart illustrating processing to be executed by the light reduction method determining unit according to the embodiment.

FIG. 6 illustrates a turret-type ND filter according to this embodiment.

FIG. 7 illustrates an ND filter in which polarizing filters are superimposed according to the embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a description will be given of embodiments according to the disclosure.

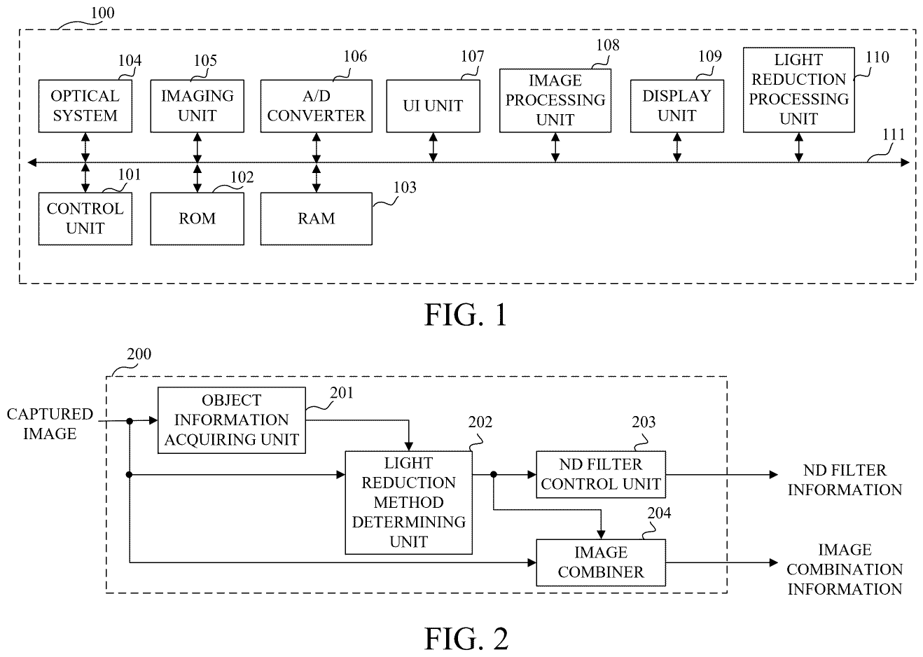

FIG. 1 illustrates the configuration of an image pickup apparatus 100 according to an embodiment. Each block in FIG. 1 can be implemented using an integrated circuit (IC) such as an ASIC or FPGA, a discrete circuit, or a combination of memory (one or more memories) and one or more processors that execute a program stored in it. A single block may be implemented using multiple integrated circuit packages, or multiple blocks may be implemented using a single integrated circuit package. The same block may also be implemented using different configurations depending on the operating environment, required capabilities, and the like. While the following description will be given of the image pickup apparatus 100 as a digital camera, the image pickup apparatus may also be a camera installed in a mobile device such as a tablet computer or smartphone.

The image pickup apparatus 100 includes a control unit 101 (one or more processors), a ROM 102 (one or more memories), a RAM 103 (one or more memories), an optical system 104, an imaging unit 105, an A/D converter 106, a user-interface (UI) unit 107, an image processing unit 108 (one or more processors), a display unit 109, and a light reduction processing unit 110 (one or more processors), all of which are interconnected by a bus 111. The control unit 101 (one or more processors) is a computer including a CPU and other components, and reads out programs for each block within the image pickup apparatus 100 from the ROM 102 (one or more memories), loads them into the RAM 103, and executes them to control the operation of each block.

The ROM 102 is an electrically erasable and recordable nonvolatile memory, and stores operation programs for each block within the image pickup apparatus 100 and parameters for the operation of each block. The RAM 103 is a rewritable volatile memory, and is used to load programs executed by the control unit 101 and other components, and to temporarily store data generated by the operation of each block in the image pickup apparatus 100.

The optical system 104 includes a plurality of lenses, including a zoom lens and a focus lens, and an aperture stop (diaphragm), and focuses light from an object onto the imaging surface of the imaging unit 105. The optical system 104 further includes an ND filter that can be inserted into and removed from the light path of the optical system to adjust exposure.

The imaging unit 105 includes an image sensor such as a CCD sensor or CMOS sensor, photoelectrically converts an optical image (object image) formed on the imaging surface by the optical system 104, and outputs an analog imaging signal to the A/D converter 106. The A/D converter 106 converts the input analog imaging signal into a digital imaging signal and outputs it. The digital imaging signal output from the A/D converter 106 is temporarily stored in RAM 103. The A/D converter 106 may be built into the imaging unit 105.

The UI unit 107 includes a pointing device, keyboard, etc., that accepts user operations on the image pickup apparatus 100. An example of a pointing device includes a touch panel and a mouse.

The image processing unit 108 performs various image processing such as white balance adjustment, color interpolation, and gamma processing for the digital imaging signal stored in RAM 103 to generate image data, and temporarily stores the image data in RAM 103. The display unit 109 includes a display device, such as an LCD that displays an image corresponding to the image data stored in RAM 103. The display unit 109 also displays a UI for receiving instructions from the user.

The light reduction processing unit 110 is a computer, such as an MPU or the like, and performs image combination processing to adjust the exposure (to obtain a light reduction effect) for the image data stored in RAM 103. The light reduction processing unit 110 also includes a light reduction information generator 200 illustrated in FIG. 2.

The light reduction information generator 200 includes an object information acquiring unit 201, a light reduction method determining unit 202, an ND filter control unit 203, and an image combiner 204. The light reduction information generator 200 corresponds to the imaging control apparatus and the image processing apparatus, and may be provided as a personal computer outside the image pickup apparatus 100.

A captured image serving as the input image illustrated in FIG. 2 corresponds to the image data generated by the image processing unit 108. An example of the format of the captured image processed by the light reduction information generator 200 is Bayer RGB (Bayer-raw). In this case, the image data includes R, G, and B pixels with linear signal characteristics.

The object information acquiring unit 201, which serves as an acquiring unit, acquires information about the object (referred to as object information hereinafter) from the captured image. The object information includes information about the area (referred to as an object area hereinafter) that contains the object, which is a target focused on by the optical system 104, as well as information about the number of saturated pixels, saturation, degree of gradation, and luminance (brightness) change amount (described below) in the object area. In this embodiment, information about A includes not only information that indicates A itself, but also information that can be converted into A.

The light reduction method determining unit 202, which serves as a selector, determines (selects) a light reduction method based on the captured image and the object information acquired by the object information acquiring unit 201. Details of the light reduction method determining unit 202 will be described later.

The ND filter control unit 203 determines the control (adjustment) of the ND filter based on the light reduction method determined by the light reduction method determining unit 202, and generates ND filter information indicating the content of the determination. More specifically, in a case where it is determined that a three-step light reduction effect is to be achieved with the ND filter, ND filter information is generated indicating the insertion of an ND filter so as to achieve a three-step light reduction effect (ND8).

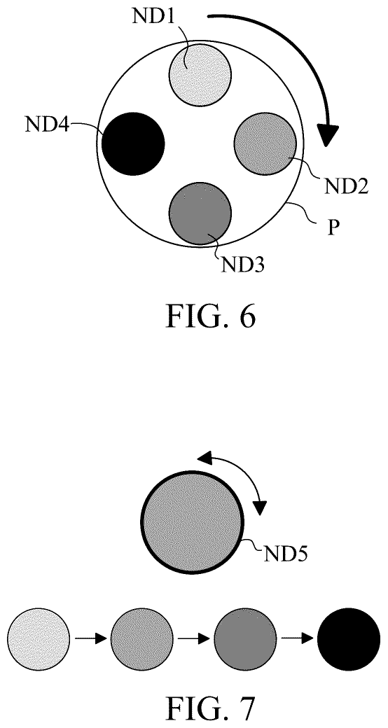

The ND filter may be configured so that the ND filter is inserted or removed by moving it together with the plate that holds a single type of ND filter. Alternatively, a turret-type ND filter as illustrated in FIG. 6 or a polarized filter-type ND filter as illustrated in FIG. 7 may be used. The turret-type ND filter has a configuration that positions a specific ND filter in the optical path by rotating a plate P on which multiple types of ND filters ND1 to ND4 with different light transmittances are arranged in the circumferential direction. The polarized filter-type ND filter allows the light amount reduction to be adjusted by rotating an ND filter ND5 formed by superimposing a plurality of polarized filters. The control unit 101 controls the insertion/removal and rotation of the ND filter (referred to as ND filter control hereinafter) based on the ND filter information. Such ND filter control can generate a captured image as an output image with a proper exposure state.

The image combiner 204, as a processing unit, performs image combination processing based on the captured image and the light reduction method determined by the light reduction method determining unit 202, and generates a combined image. More specifically, in a case where the light reduction method determining unit 202 determines that a three-step (ND8) light reduction effect will be obtained by the image combination processing, it generates image combination information indicative of the content of this determination. The image combiner 204 performs image combination processing based on the image combination information to generate a combined image with a three-step light reduction effect. At this time, the image combiner 204 performs image combination processing to combine a plurality of divided exposure images obtained by a plurality of divided image captures performed by dividing a predetermined exposure time into a plurality of parts. Minimizing the non-exposure time, i.e., the time when no exposure is performed between the end of exposure by the imaging unit 105 to generate one divided exposure image and the start of exposure by the imaging unit 105 to generate the next divided exposure image can generate a combined image as an output image in which blurring of the object image is suppressed. The light reduction method used in the image combination processing may be, for example, the method disclosed in Japanese Patent Application Laid-Open No. 2023-141237, or other methods.

The degree (number of steps) of the light reduction effect in the image combination processing may be changed for each area within the combined image. For example, image combination processing may be performed so that a two-step light reduction effect is achieved for areas where the pixel value is equal to or greater than a threshold, and a one-step light reduction effect is achieved for areas where the pixel value is less than the threshold. The image combiner 204 outputs information about the areas where the light reduction effect is achieved in the image combination processing, as image combination information.

Information on the light reduction effect achieved by inserting an ND filter or by image combination processing (such as the number of light reduction steps and the area where the light reduction effect is achieved) is recorded as meta information in the captured image generated by capturing an image with an ND filter inserted or the combined image generated by image combination processing, i.e., the output image. ND filter control and image combination processing may also be performed based on newly acquired images, previously recorded images, and meta information of previously recorded images.

As discussed above, this embodiment can obtain an output image (captured image or combined image) with a proper exposure state by selecting and performing ND filter control or image combining processing based on object information.

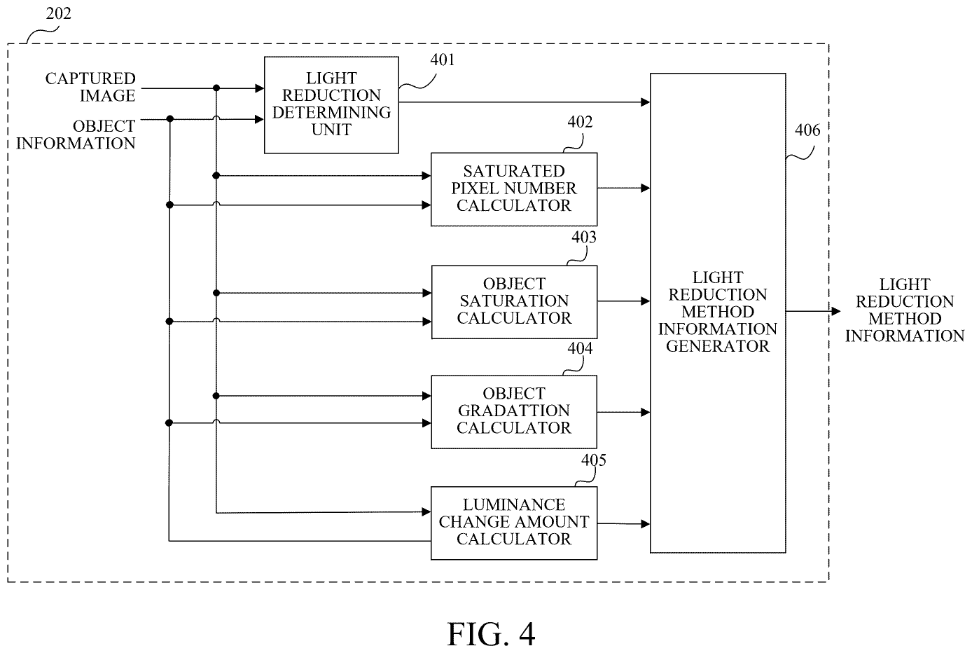

FIG. 4 illustrates the configuration of the light reduction method determining unit 202. The light reduction method determining unit 202 includes a light reduction determining unit 401, a saturated pixel number calculator 402, an object saturation calculator 403, an object gradation calculator 404, a luminance change amount calculator 405, and a light reduction method information generator 406.

The light reduction determining unit 401 determines whether the object area in the captured image is overexposed, and outputs an exposure determination flag indicating the result of the determination. The saturated pixel number calculator 402 calculates the number of saturated pixels, which is the number of luminance-saturated pixels in the object (i.e., the object area as an image area).

The object saturation calculator 403 calculates the saturation of the object in the object area. More specifically, the object saturation calculator 403 performs interpolation processing using smoothing filter processing for an image in Bayer-raw format, generates an average interpolated image in RGB444 format, and calculates the saturation of the object from the average interpolated image.

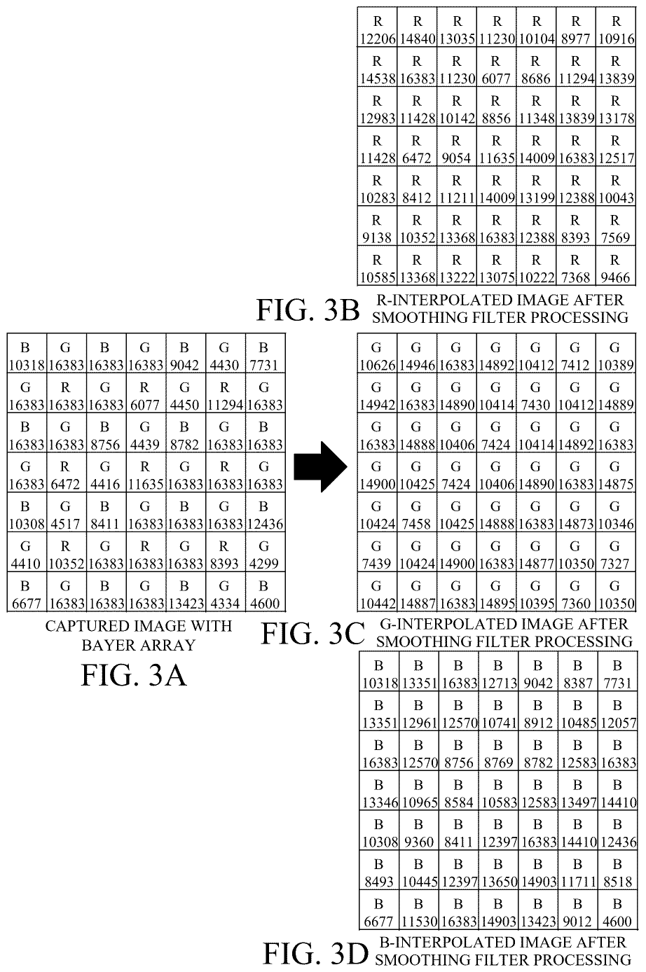

An example of a method for generating an average interpolated image is as follows: FIGS. 3A, 3B, 3C, and 3D illustrate an example of performing interpolation processing using 3×3 smoothing filter processing for a captured image in Bayer-raw format. FIG. 3A illustrates the captured image in the Bayer-raw format (simply referred to as Bayer array in the figures). FIG. 3B illustrates an R-interpolated image obtained by applying the smoothing filter processing to the R pixels in the captured image with the Bayer array. FIG. 3C illustrates a G-interpolated image obtained by applying the smoothing filter processing to the G pixels of the captured image with the Bayer array. FIG. 3D illustrates a B-interpolated image obtained by applying the smoothing filter processing to the B pixels of the captured image with the Bayer array. The three- to four-digit numbers written below each pixel indicate the pixel value of that pixel.

The pixel values of the R-interpolated image illustrated in FIG. 3B are calculated by applying the 3×3 smoothing filter processing to the captured image of FIG. 3A. The pixel values of the reference R pixels corresponding to the R pixels in the captured image remain unchanged, and the pixel values of the other R pixels are calculated by interpolation using the pixel values of the reference R pixels. In this way, the pixel values (R values) of all R pixels in the R-interpolated image are determined. In addition, the pixel values (G values) of all G pixels in the G-interpolated image and the pixel values (B values) of all B pixels in the B-interpolated image illustrated in FIGS. 3C and 3D are determined in a similar manner.

The object saturation is calculated using the following equation (1):

$$Chro = ( {MAX}_{RGB} - {MIN}_{RGB} ) / {MAX}_{RGB} \qquad ( 1 )$$

In equation (1), Chro represents object saturation calculated from the average interpolated image in RGB444 format. MAX_{RGB} represents the maximum value of the R, G, and B values in the object area in the average interpolated image in the RGB444 format. MIN_{RGB} represents the minimum value of the R, G, and B values in the object area in the average interpolated image.

The object gradation calculator 404 calculates the gradation degree, which indicates the smoothness of the object gradation in the object area. More specifically, the object gradation calculator 404 performs interpolation processing using the smoothing filter for the captured image in the Bayer-raw format, outputs an average interpolated image in the RGB444 format, and calculates the gradation degree from this average interpolated image. The method for generating the average interpolated image is the same as that used by the object saturation calculator 403.

The gradation degree is calculated using the following equation (2):

$$Grad = \frac{1}{N} {\sum }_{i = 1}^{N} \sqrt{{( {R}_{i + 1} - {R}_{i} )}^{2} + {( {G}_{i + 1} - {G}_{i} )}^{2} + {( {B}_{i + 1} - {B}_{i} )}^{2}} \qquad ( 2 )$$

In equation (2), Grad represents the gradation degree. N represents the number of pixels in the object area in the average interpolated image in RGB444 format. i represents the position of each pixel. R, G, and B indicate the R, G, and B values, respectively, in the object area in the average interpolated image. The smoothness of the gradation can be evaluated by calculating an average from a difference in pixel values of adjacent pixels using equation (2).

The luminance change amount calculator 405 calculates a luminance change amount of the object in the object area. The luminance change amount is calculated using equation (3) below:

$$Val = ( {R}_{t + 1} - {R}_{t} ) + ( {G}_{t + 1} - {G}_{t} ) + ( {B}_{t + 1} - {B}_{t} ) \qquad ( 3 )$$

Val represents the luminance change amount, and t represents time. R, G, and B represent the R, G, and B values, respectively, in the object area in the average interpolated image in RGB444 format. The luminance change amount can be evaluated by calculating a time change amount in pixel value at the same pixel position using equation (3).

The light reduction method information generator 406 generates the above ND filter information and image combination information from the exposure determination flag, the number of saturated pixels, the object saturation, the object gradation degree, and the object luminance change amount.

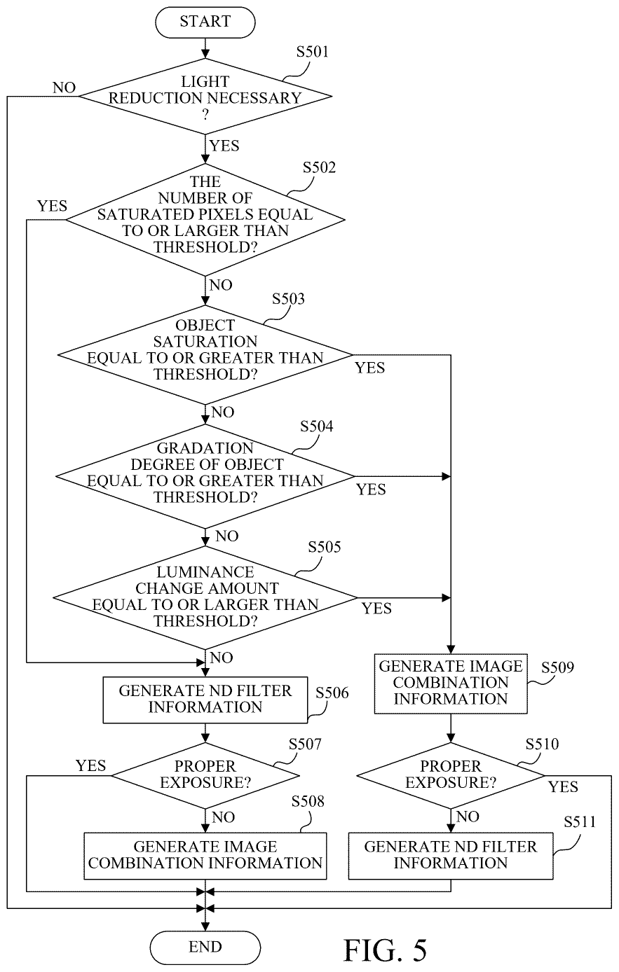

A flowchart in FIG. 5 illustrates processing to be executed by the light reduction method determining unit 202 in accordance with a program.

In step S501, the light reduction method determining unit 202 determines whether the exposure determination flag indicates an overexposed state, i.e., whether it is necessary to obtain a light reduction effect by ND filter control or image combination processing. In a case where it is the overexposed state, it determines that the light reduction effect is necessary and the flow proceeds to step S502, but in a case where it is not an overexposed state, this flow ends.

In step S502, the light reduction method determining unit 202 determines whether the number of saturated pixels is equal to or larger than a threshold value as a first predetermined value, i.e., whether it is necessary to prioritize the use of an ND filter to obtain the light reduction effect. In a case where the number of saturated pixels is equal to or larger than the threshold value, it determines that the use of the ND filter is to be prioritized and the flow proceeds to step S506, but in a case where the number of saturated pixels is smaller than the threshold value, the flow proceeds to step S503.

In step S503, the light reduction method determining unit 202 determines whether the saturation of the object is equal to or greater than a threshold value as a second predetermined value, i.e., whether it is necessary to prioritize the use of image combination processing to achieve the light reduction effect. In a case where the saturation is equal to or greater than the threshold value, it determines that the use of image combination processing is to be prioritized and the flow proceeds to step S509. In a case where the saturation is less than the threshold value, the flow proceeds to step S504.

In step S504, the light reduction method determining unit 202 determines whether the gradation degree of the object is less than a threshold value as a third predetermined value, i.e., whether it is necessary to prioritize the use of image combination processing to achieve the light reduction effect. In a case where the gradation degree is equal to or greater than the threshold value, it determines that the use of image combination processing is to be prioritized and the flow proceeds to step S509. In a case where the gradation degree is less than the threshold value, the flow proceeds to step S505.

In step S505, the light reduction method determining unit 202 determines whether the luminance change amount of the object is equal to or larger than a threshold value as a fourth predetermined value, i.e., whether it is necessary to prioritize the use of image combination processing to achieve the light reduction effect. In a case where the luminance change amount is larger than or equal to the threshold value, it is determined that the use of image combination processing is prioritized, and the flow proceeds to step S509; in a case where the luminance change amount is smaller than the threshold value, the flow proceeds to step S506.

In step S506, the light reduction method determining unit 202 generates ND filter information based on the exposure state of the captured image. For example, in a case where the exposure state is a three-step overexposure state, the ND filter information is generated so that three steps of light reduction effect will be obtained by inserting an ND filter. This causes the control unit 101 to insert the ND filter into the optical path.

Next, in step S507, the light reduction method determining unit 202 determines whether the light reduction effect achieved by inserting the ND filter causes the exposure state of the object area to be proper (within a predetermined range). For example, in a case where the original exposure state in step S506 was a five-step overexposure state, and inserting the ND filter provided a three-step light reduction effect, the exposure state is determined to be a two-step overexposure state and this exposure state is determined to be improper. In a case where the exposure state is improper, the flow proceeds to step S508; in a case where the exposure state is proper, the image processing unit 108 generates and outputs a captured image having a light reduction effect using an ND filter, and this flow ends.

In step S508, the light reduction method determining unit 202 generates image combination information for achieving the light reduction effect through image combination processing. For example, in a case where the exposure state is in a two-step exposure state, image combination information is generated so that a two-step light reduction effect is achieved through image combination processing. Thereby, the light reduction processing unit 110 performs image combination processing to generate a combined image with a proper exposure state. This flow then ends.

On the other hand, in step S509, the light reduction method determining unit 202 generates image combination information for image combination processing based on the exposure state of the captured image. For example, in a case where the exposure state is a three-step overexposure state, image combination information is generated so that a three-step light reduction effect is achieved through image combination processing. Thereby, the light reduction processing unit 110 performs image combination processing to generate a combined image having a light reduction effect.

Next, in step S510, the light reduction method determining unit 202 determines whether the exposure state of the object area in the combined image with the light reduction effect is proper (within a predetermined range). For example, in a case where the original exposure state in step S509 was a five-step overexposure state and the image combination processing provided a three-step light reduction effect, it determines that the exposure state is a two-step overexposure and improper. In a case where the exposure state is improper, the flow proceeds to step S511; in a case where it is proper, the combined image generated in step S509 is output and this flow ends.

In step S511, the light reduction method determining unit 202 generates ND filter information for achieving the light reduction effect by inserting an ND filter. For example, in a case where the exposure state is a two-step overexposure state, ND filter information is generated so that a two-step light reduction effect can be achieved by inserting an ND filter. Thereby, the control unit 101 inserts an ND filter into the optical path, and the image processing unit 108 generates and outputs a captured image with the light reduction effect achieved by the ND filter. The flow then ends.

In this embodiment, either ND filter insertion or image combination processing is selected according to the results of the four determinations made in steps S502 to S505. However, it is not necessary to make all four determinations; it is sufficient to make at least one determination. For example, image combination processing may be selected in a case where the number of saturated pixels is below the threshold value in step S502, or ND filter insertion may be selected in a case where the saturation is below the threshold value in step S503. The ND filter insertion may be selected in a case where the gradation degree is equal to or greater than the threshold value in step S504.

In the image pickup apparatus disclosed in Japanese Patent Application Laid-Open No. 2013-157688, image blur, depth of field, noise, and the like differ between images captured after exposure adjustment by inserting or removing an ND filter and images captured after exposure adjustment using other methods. The higher the density of the ND filter, the more noticeable the decrease in saturation and density unevenness become. In addition, it is difficult to smoothly change exposure in a case where the ND filter density is switched according to a luminance change during moving image capturing. In achieving a light reduction effect through image combination processing, such as in the image pickup apparatus disclosed in Japanese Patent Application Laid-Open No. 2023-141237, the saturated pixel values may differ from those of an image captured through an ND filter.

On the other hand, according to this embodiment, the determination as to whether to prioritize the ND filter or image combination processing to achieve the light reduction effect is based on the number of saturated pixels, the saturation of the object, the gradation degree, and the luminance change amount. Thereby, the problems that may occur in an attempt to achieve a light reduction effect through the ND filter or image combination processing can be suppressed.

### OTHER EMBODIMENTS

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each embodiment can provide an excellent light reduction effect in imaging.

This application claims the benefit of Japanese Patent Application No. 2024-220204, which was filed on Dec. 16, 2024, and which is hereby incorporated by reference herein in its entirety.

What is claimed is:

1. A control apparatus comprising:
one or more memories storing instructions; and
one or more processors that, upon execution of the instructions, operate to:
acquire information about an object included in an image generated by imaging through an optical system, and
select, based on the information about the object, at least one of inserting an ND filter into an optical path in the optical system and performing combination processing by combining a plurality of images generated by the imaging to achieve a light reduction effect.

2. The control apparatus according to claim 1, wherein the information about the object includes information about the number of saturated pixels in the object.

3. The control apparatus according to claim 2, wherein the one or more processors operate to select insertion of the ND filter in a case where the number of saturated pixels is larger than a predetermined value.

4. The control apparatus according to claim 2, wherein the one or more processors operate to select the combination processing in a case where the number of saturated pixels is less than a predetermined value.

5. The control apparatus according to claim 1, wherein the information about the object includes information about saturation of the object.

6. The control apparatus according to claim 5, wherein the one or more processors operate to select the combination processing in a case where the saturation is greater than a predetermined value.

7. The control apparatus according to claim 5, wherein the one or more processors operate to select insertion of the ND filter in a case where the saturation is lower than a predetermined value.

8. The control apparatus according to claim 1, wherein the information about the object includes information about a gradation degree of the object.

9. The control apparatus according to claim 8, wherein the one or more processors operate to select the combination processing in a case where the gradation degree is lower than a predetermined value.

10. The control apparatus according to claim 8, wherein the one or more processors operate to select insertion of the ND filter in a case where the gradation degree is higher than a predetermined value.

11. The control apparatus according to claim 1, wherein the information about the object includes information about a luminance change amount of the object over time.

12. The control apparatus according to claim 11, wherein the one or more processors operate to select the combination processing in a case where the luminance change amount is greater than a predetermined value.

13. The control apparatus according to claim 11, wherein the one or more processors operate to select insertion of the ND filter in a case where the luminance change amount is smaller than a predetermined value.

14. The control apparatus according to claim 1, wherein the one or more processors operate to select the combination processing in a case where an exposure state of the object in the image generated by the imaging with the ND filter inserted is not within a predetermined range.

15. The control apparatus according to claim 1, wherein the one or more processors operate to select insertion of the ND filter in a case where an exposure state of the object in the image generated by the combination processing is not within a predetermined range.

16. The control apparatus according to claim 1, wherein the combination processing provides a different light reduction effect to each area in an image obtained by combining the plurality of images.

17. The control apparatus according to claim 1, wherein the one or more processors operate to record information about insertion of the ND filter or the light reduction effect obtained by the combination processing in an output image generated by imaging with the ND filter inserted or the combination processing.

18. An image pickup apparatus comprising:
a control apparatus;
an imaging element that captures the image;
wherein the control apparatus includes:
one or more memories storing instructions; and
one or more processors that, upon execution of the instructions, operate to:
acquire information about an object included in an image generated by imaging through an optical system, and
select, based on the information about the object, at least one of inserting an ND filter into an optical path in the optical system and performing combination processing by combining a plurality of images generated by the imaging to achieve a light reduction effect.

19. A control method comprising:
acquiring information about an object included in an image generated by imaging through an optical system; and
selecting, based on the information about the object, at least one of inserting an ND filter into an optical path in the optical system and performing combination processing by combining a plurality of images generated by the imaging to achieve a light reduction effect.

20. A non-transitory computer-readable storage medium storing a program that causes a computer to execute the control method according to claim 19.
